(19) United States
(12) Patent Application Publication
(10) Pub. No.: US 2013/0043273 A1
(43) Pub. Date: Feb. 21, 2013

(54) METERING DEVICE FOR THE METERED DISPENSION OF FLUID PREPARATIONS, AND METHODS RELATED THERETO

(71) Applicants: Hyeck Hee Lee, St. Ingbert (DE); Ute Steinfeld, St. Ingbert (DE); Jungtae Kim, Saarbrucken (DE); Holger Krause, Neunkirchen (DE); Jihwang Park, Saarbrucken (DE); Kwang Ho Kim, Saarbrucken (DE); Bianca Schweiger, Saarbrucken (DE); Sebastian Beck, St. Ingbert (DE)

(72) Inventors: Hyeck Hee Lee, St. Ingbert (DE); Ute Steinfeld, St. Ingbert (DE); Jungtae Kim, Saarbrucken (DE); Holger Krause, Neunkirchen (DE); Jihwang Park, Saarbrucken (DE); Kwang Ho Kim, Saarbrucken (DE); Bianca Schweiger, Saarbrucken (DE); Sebastian Beck, St. Ingbert (DE)

(73) Assignee: KIST-EUROPE FORSCHUNGSGESELLSCHAFT MBH, Saarbrucken (DE)

(21) Appl. No.: 13/395,368

(22) PCT Filed: Sep. 9, 2010
(86) PCT No.: PCT/EP2010/005557

§ 371 Date: Oct. 23, 2012

(30) Foreign Application Priority Data
Sep. 9, 2009 (DE) 10 2009 040 783.9

(51) Int. Cl. B67D 1/00; B67D 7/74

(52) U.S. Cl. 222/82; 222/129

(57) ABSTRACT

The present invention relates to a metering device for metered output of liquid preparations in the medicinal, pharmaceutical or cosmetic field or in the foodstuffs sphere, the use of preservatives being able to be dispensed with. Furthermore, the invention relates to a method for filling and also the use of a metering device according to the invention.

The present invention relates to a metering device for metered output of liquid preparations in the medicinal, pharmaceutical or cosmetic field or in the foodstuffs sphere, the use of preservatives being able to be dispensed with. Furthermore, the invention relates to a method for filling and also the use of a metering device according to the invention.

The metering devices known from the state of the art comprise a storage container and also a metering pump. An example of a metering pump is given in DE 10 2008 027 987. The metering pump described there comprises a hollow body connected to a cap, a pump piston, a pump chamber and also a nozzle which is connected to the pump chamber via an outlet channel. Storage containers with pressure equalisation are used in combination with such a metering pump.

The metering devices known from the state of the art are frequently provided with suitable seals so that the contents of the storage container are sealed hermetically. Nevertheless, the use of preservatives during storage of a large number of liquid preparations has to date been essential. The use of preservatives leads however to intolerances in consumers, in particular if these are people subject to allergies.

Since the individual constituents of a preparation are often stable for longer with separate storage, sets are proposed by the state of the art which make it possible for the consumer to mix the individual constituents personally before first-time use. Such sets are however difficult to handle and, during mixing of the constituents, contamination of the final preparation can result.

Starting from the state of the art, it is now the object of the present invention to make available a metering device and also a method for filling and a use of a metering device which make it possible to prolong the stability of a preparation. In addition, the metering device is intended to be able to be produced simply and economically and in particular to be easy to handle by the consumer.

These objects are achieved by the metering device according to claim 1 and also by the production method thereof according to claim 20 and use thereof according to claim 22. Advantageous developments of the present invention are described in the dependent claims.

According to the invention, the metering device for metered output of a liquid preparation which comprises at least two starting substances has a storage vessel, for receiving at least the first starting substance, with an opening, an inner vessel for receiving the second starting substance and also an output unit having a passage channel with two channel openings. The inner vessel is disposed in the region of the opening of the storage vessel such that it seals the storage vessel. The output unit is disposed, with one of its channel openings which is termed subsequently inlet opening, in the region of the storage vessel opening orientated towards the storage vessel and connected to the storage vessel in a sealed manner. Furthermore the region of the output unit orientated towards the storage vessel is configured as a penetration unit which can be introduced into the opening of the storage vessel and/or can be guided in the latter. In the region of the opening of the storage vessel between storage vessel and output unit, an inner vessel, which is sealed at least relative to the storage vessel, for receiving the second substance is disposed. By introducing and/or guiding the penetration unit into and/or in the opening, the inner vessel can be penetrated with the help of the penetration unit and the metering device can be activated therewith.

Both before first-time use and during use, a sealed connection between the output unit, the storage vessel and also the inner vessel is thereby ensured. This is provided irrespective of the operating states and also of the environmental conditions. As a result, for example contamination of the contents can be effectively avoided.

Before first-time use of the metering device according to the invention, the metering device is situated in a non-activated position, i.e. the penetration unit is disposed at a spacing from the inner vessel and the inner vessel has not yet been penetrated so that the second starting substance is still stored separately from the first starting substance.

The metering device has a sealed connection between the storage vessel and the output unit, in particular before and also during activation of the metering device. Hence ambient air cannot reach the contents of the metering device at any time.

By separating the substances before use, preservatives can be dispensed with during storage.

By activating the metering device, the latter moves into a position of use in which the inner vessel is penetrated and the contents of the inner vessel are introduced into the storage vessel. The position of use can be indicated for example by a colour, in particular generally tolerable natural colours being possible as colour.

The idea of the present invention is based therefore on the principle of storing the starting substances separately from each other until first-time use and preferably sealing them respectively hermetically. The stability of the contents of the metering device is therefore prolonged by producing the final liquid preparation by mixing the first and the second starting substance upon first-time use.

The contents of the inner vessel and also of the storage vessel are preferably sealed hermetically leaving the manufacturer, during and after activation. The hermetic sealing of the storage vessel can be effected by fitting, in particular by welding-on or glueing-on, the inner vessel in the storage vessel opening. The transition between storage vessel and output unit is preferably sealed with a seal and, for hermetic sealing of the interior of the output unit, the channel of the output unit has a nozzle or an additional closing cap with sealing effect preferably at the channel opening orientated away from the storage vessel.

Preferably, the starting substances are chosen such that the first starting substance is a liquid substance, preferably water, whilst the second starting substance is a powder or an oily emulsifiable substance. Preferably, the first and second substance are chosen such that the second substance can be dissolved or emulsified in the first substance or such that the second substance reacts with the first substance.

Activation, i.e. the transition from the non-activated position into the position of use, can be achieved by a movement of the output unit in the direction of the storage vessel and in the direction of the inner vessel. Such a movement can be achieved in particular by pressing or turning.

The opening of the storage vessel can have a circular, oval or polygonal configuration. The storage vessel can be configured for example as a container with a corresponding cross-sectional profile to the opening. Alternatively, the container can however also have a cross-section which differs from the opening, for example a square opening and a container with a circular cross-section.

Preferably, the opening of the storage container is configured as a neck. In such an embodiment, the inner vessel can be disposed in a region of the neck orientated towards the storage vessel, whilst the penetration unit of the output unit can be disposed, in the non-activated state of the metering device, at least partially in the region of the neck orientated away from the storage vessel.

Preferably, the metering device is configured such that the output unit, after movement of this in the direction of the storage vessel and after penetration of the inner vessel, is locked to the storage vessel. For this purpose, the output unit preferably has a hollow cylinder or a hollow prism which surrounds the penetration unit. The hollow cylinder is thereby configured preferably as a cylinder which is hollowed out along its entire length and has a suitable base, for example with a circular, oval or banana-shaped base. The hollow cylinder or the hollow prism have undercuts on their inside at least in regions. In addition, the storage vessel preferably has undercuts in the region of its opening, in particular in the case of an opening shaped as a neck. If now output unit and storage vessel are moved towards each other, then the undercuts of the hollow cylinder or of the hollow prism and of the storage vessel engage one in the other or engage respectively with a suitably shaped seal and the output unit locks onto the storage vessel.

For water- and air-tight connection of the output unit to the storage vessel, the metering device preferably has a flexible plastic material tube as seal, the plastic material tube inter alia being able to produce the sealed connection of storage vessel and output unit. The one end of the plastic material tube surrounds the opening of the storage vessel and the second end of the tube is disposed such that it surrounds in particular the inlet opening of the channel of the output unit. The end of the tube orientated towards the output unit is thereby preferably connected to the hollow cylinder or hollow prism surrounding the penetration unit. If the storage vessel is manufactured from plastic material, this can be configured in one part with the plastic material tube.

The plastic material tube preferably has one or two regions with respectively at least one thickened portion. The thickened portion preferably extends along over the entire circumference of the respective tube region. The respective thickened portions preferably engage in the undercuts of the hollow cylinder or of the hollow prism and/or of the storage vessel. In the activated state, the flexible plastic material tube is rolled inwards into the output unit, in particular into a region between penetration unit and hollow cylinder or hollow prism of the output unit so that the thickened portion in the region orientated towards the storage vessel and/or the thickened portion in the region orientated towards the output unit engage one in the other and the output unit locks on the storage vessel. For example an improved seal between the storage vessel and the output unit is produced therewith.

The penetration unit can be configured as a pointed inlet connection piece, the one end of which leads into the inlet opening of the output unit. In addition, the inlet connection piece can have, at the end thereof orientated away from the inlet opening, a cutting collar, a saw collar, a toothed collar or at least one tine which is suitable for penetrating the inner vessel. Alternatively, the penetration device can also be configured as a separate cutting collar, saw collar, toothed collar, in particular as a diagonal cutting collar, saw collar or toothed collar, or at least one tine which is suitable for penetrating the inner vessel or as a mandril which is disposed preferably in the vicinity of the inlet opening of the output unit.

The metering device according to the invention can be used for spraying a liquid substance. For this purpose, the output unit is preferably configured as a metering pump, as is known from the state of the art.

Preferably, a metering pump used in conjunction with the metering device according to the invention comprises an inlet channel, a pump piston, a pump chamber and a nozzle which is connected to the pump chamber via an outlet channel, the inlet channel and the outlet channel of the metering pump corresponding in this case to the channel of the output unit. Through the inlet opening, the liquid preparation can be introduced from the storage vessel into the pump chamber. By moving the pump piston, the liquid is conveyed outwards from the pump chamber through the outlet channel and the nozzle.

According to the field of application, the nozzle can be disposed in the pump head such that the liquid is issued at the side orientated away from the storage vessel or laterally.

Alternatively, spraying of the liquid from the storage vessel can also be effected by pressing an elastic storage vessel. The output unit is then configured preferably as output cap with channel in which a nozzle is disposed. After penetration of the inner vessel, the liquid can be sprayed out of the storage vessel by pressing in the walls of the storage vessel body.

In addition, the metering device according to the invention can also be configured as a disposable syringe. In this case, the output unit is preferably configured merely as an output cap which has a channel. The disposable syringe has a plunger which forms the base of the storage vessel which is orientated away from the output cap. After penetration of the inner vessel, a cannula can be placed on the output cap. By moving the plunger in the direction of the output cap, the liquid can be sprayed out of the storage vessel through the channel of the output cap.

Irrespective of the shaping of the output unit, the storage vessel is preferably configured as a container which has a pressure-equalisation device. For example, a bag, bellows or a bottle with pressure-equalisation, in particular a trailing piston bottle or a syringe can be used, the plunger serving as pressure-equalisation device.

Preferably, the storage vessel includes a bottle with a pressure-equalisation opening in which bellows with a base are inserted. Alternatively, a trailing piston base can be present in the bottle with pressure-equalisation opening, which base can be moved preferably by means of bottomless bellows and/or a spring.

As materials for the storage vessel, in particular materials which show no reaction with the first starting substance and also with the liquid preparation are chosen. In particular, glass or plastic material containers are used.

The inner vessel is preferably designed such that it is chemically resistant, has low moisture absorption and/or can be used within a wide temperature range. The inner vessel therefore consists preferably of a metal, in particular aluminium, of a plastic material or of a glass or comprises one of these materials. There may be mentioned as an example of a plastic material, for example polychlorotrifluoroethylene (PCTFE), which is non-inflammable, chemically resistant, has a moisture absorption close to zero and can be used at temperatures within a range of −240° to 204°. In addition to PCTFE, also PE/PCTFE/PE multilayer films are possible (PE=polyethylene). Also a PE/PCTFE film which is laminated on one side is possible. As an alternative, cycloolefin copolymers (COC) are possible, which have in fact poorer barrier properties than PCTFE but in contrast are more economical. COC are in addition scratch-sensitive and can therefore be coated on both sides with PP (polypropylene) as multilayer film. PP serves thereby as protective layer for the scratch-sensitive COC and in addition as an adhesive layer. Furthermore, aluminium with a plastic material coating (protection against oxidation) or suitable polymer films or even multilayer films can be used.

The inner vessel is configured as a closed vessel, the contents of which are sealed hermetically. The inner vessel furthermore seals the contents of the storage vessel.

The inner vessel can have a first and a second layer, between which the contents of the inner vessel are sealed. The two layers are connected to each other permanently at their edges and to the storage vessel, for example to each other, and are welded or glued or laminated onto the opening of the storage vessel.

If the first and second layer are produced from PCTFE, then they have a thickness in the range of a few 10 μm to a few 100 μm, in particular a thickness of 102 μm.

The storage vessel and/or the inner vessel and/or the channel of the output unit can have, in particular in and/or on their inner walls, a bactericidal agent, in particular a bactericidal coating or bactericidal inserts. Bactericidal agents preferably comprise silver or silver salts, such as e.g. silver chloride.

The output unit can have a filter in the region of the inlet channel, which filter clears the final preparation of residues contained in the final liquid preparation and protects the channel of the output unit from blockage by residues of the inner vessel.

The metering device can have possibly at least one supplementary vessel for receiving a third starting substance or for receiving a colourant. Such a supplementary vessel is preferably disposed in the region of the opening of the storage vessel on the side of the inner vessel orientated towards the storage vessel or on the side of the inner vessel orientated towards the output unit or next to the inner vessel and can be penetrated with the help of the penetration unit of the output unit. If the final liquid preparation consists therefore for example of three starting substances which are stable for a longer time separately from each other than in a mixture, then both the inner vessel and the supplementary vessel are disposed for example in the opening of the storage container. Upon activation of the metering device, the inner vessel and the supplementary vessel are penetrated so that the contents thereof permeate into the storage vessel and the three starting substances are mixed to form the preparation, the mixing being able to be accelerated by shaking.

Activation of the output unit can be effected for example by a pressing or screwing movement.

In the case of activation by pressing, the storage vessel preferably has a hollow cylinder or a hollow prism which surround the opening of the storage vessel. The hollow cylinder is thereby configured again preferably as a cylinder which is hollowed out along its entire length and has a suitable base, for example with a circular, oval or banana-shaped base. The base of the hollow cylinder or of the hollow prism is thereby chosen preferably such that at least the penetration unit and preferably the penetration unit, and surrounding this, a hollow cylinder or hollow prism of the output unit can be introduced into the interior of the hollow cylinder or of the hollow prism of the storage vessel. The hollow cylinder or the hollow prism can serve, in particular during the pressing movement, as a guide for the output unit in order to avoid tilting.

If the activation is intended to be effected by a screwing movement, then the metering device has a screwed bush for guiding the output unit in the direction of the storage vessel. Such a screwed bush preferably has one or more threads. By turning the screwed bush, the output unit is drawn in the direction of the storage vessel.

In order to protect the non-activated position of the metering device from unintentional activation, the metering device preferably has a locking mechanism which is configured for example as a locking ring between the storage vessel and the output unit.

For protection from contamination, the output unit can be provided in addition with a closing cap which can be removed after activation preferably before each occasion of use and possibly put on again after each occasion of use.

In the metering device according to the invention, the inner vessel and/or the storage vessel can contain protective gas and/or inert gas in order to protect the contents from oxidation and/or hydrolysis. This can also apply to a supplementary vessel which is possibly present.

Furthermore, protective gas and/or inert gas can be passed through the first starting substance, possibly before filling. This can also apply to a second or third starting substance.

The inner vessel and/or the storage vessel can preferably be filled under an atmosphere comprising protective gas and/or inert gas. Also a supplementary vessel which is possibly present can be filled in this way.

The protective gas can hereby be selected from nitrogen N₂, carbon dioxide CO₂ or mixtures hereof.

The inert gas is preferably selected from nitrogen, noble gases, such as e.g. helium He or argon Ar, or mixtures hereof.

In the storage vessel of the metering device according to the invention, bellows can be disposed, as a result of which a hermetic seal of the metering device until the end of use is ensured.

The present invention relates furthermore to a method for filling a metering device according to the invention. In a first step, the storage vessel is thereby filled with a first starting substance. In a second step, the inner vessel is fitted permanently in the region of the opening of the storage vessel. The inner vessel can thereby be filled even before application or, in particular if the inner vessel consists of a first and a second layer, be filled between application of the first layer on the storage vessel and application of the second layer. In a third step, the output unit is finally placed on the storage vessel. If the metering device comprises a flexible plastic material tube, then the tube is secured, before the output unit is put in place, to form a seal on the latter and subsequently, when the output unit is put in place, is put over the opening of the storage vessel.

Activation of the output unit is effected by moving the output unit in the direction of the storage vessel, the penetration unit of the output unit penetrating the inner vessel and thus the second starting substance being introduced into the storage vessel. The output unit is thereby moved by pressing the output unit in the direction of the storage vessel or by turning the screwed bush in the direction of the storage vessel. In order to obtain a uniform final preparation more rapidly, the metering device is preferably shaken in order to mix the first and the second starting substance and possibly the third or further starting substances.

A use of the metering device according to the invention is the administering of medicinal products, pharmaceutical products, cosmetic products, cleaning agents, chemicals, foodstuffs, food supplements or liquid spices/herbs, the use of preservatives being able to be dispensed with. In the case of cosmetic products, for example perfume without alcohol and preservatives can be made stable for a longer time.

Furthermore, a use of the metering device for administering preparations which can comprise vitamins, minerals, enzymes, coenzymes, plant extracts, bacteria, yeasts as individual substance or mixtures of a plurality of these substances is according to the invention.

The present invention is explained in more detail with reference to the subsequent Figures without being restricted to the special embodiments represented in the Figures.

There are shown

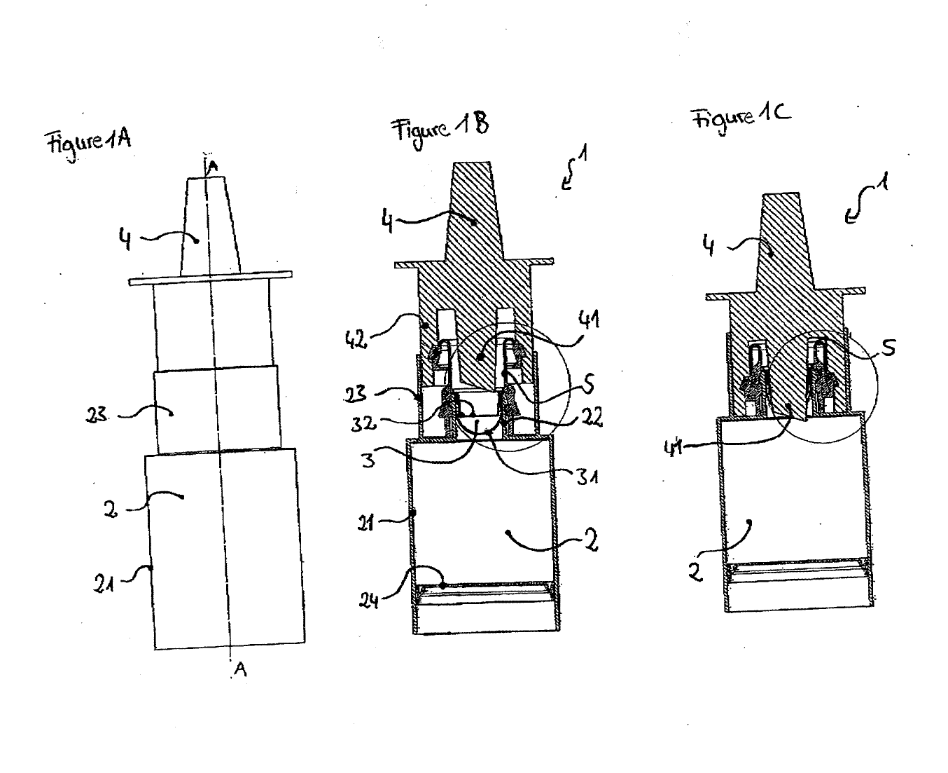

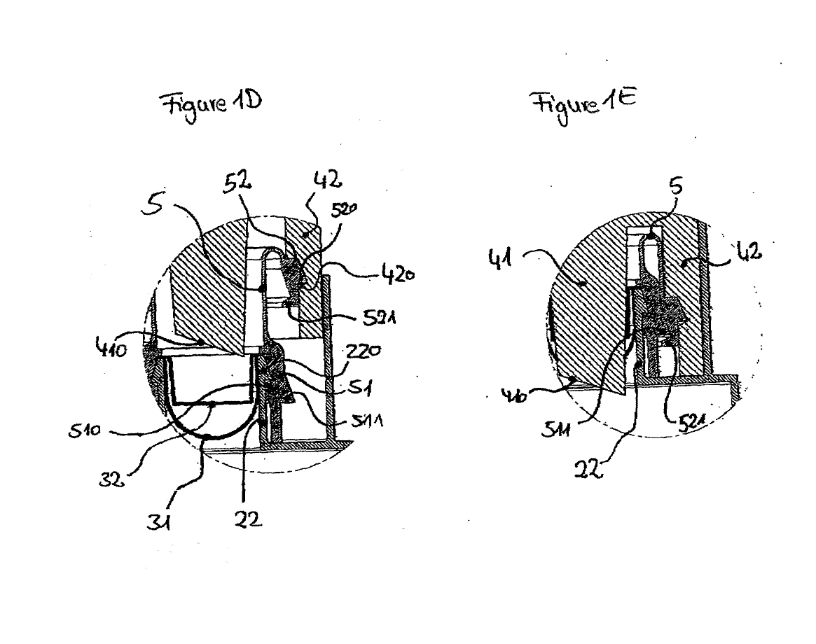

FIGS. 1A-E a longitudinal section through a metering device according to the invention with a metering pump in non-activated position and in position of use;

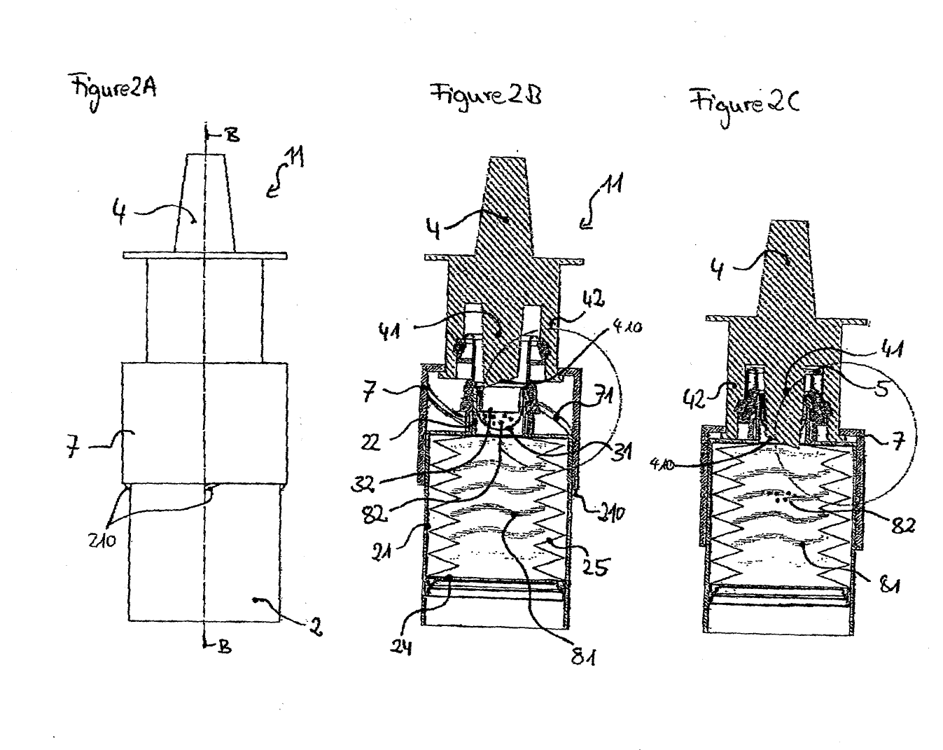

FIGS. 2A-E a longitudinal section through a further metering device according to the invention with a metering pump in non-activated position and in position of use;

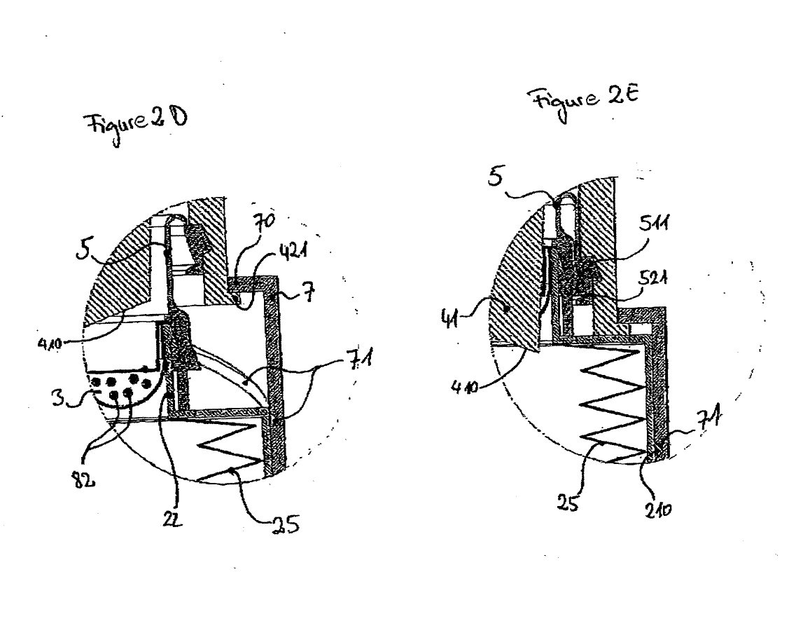

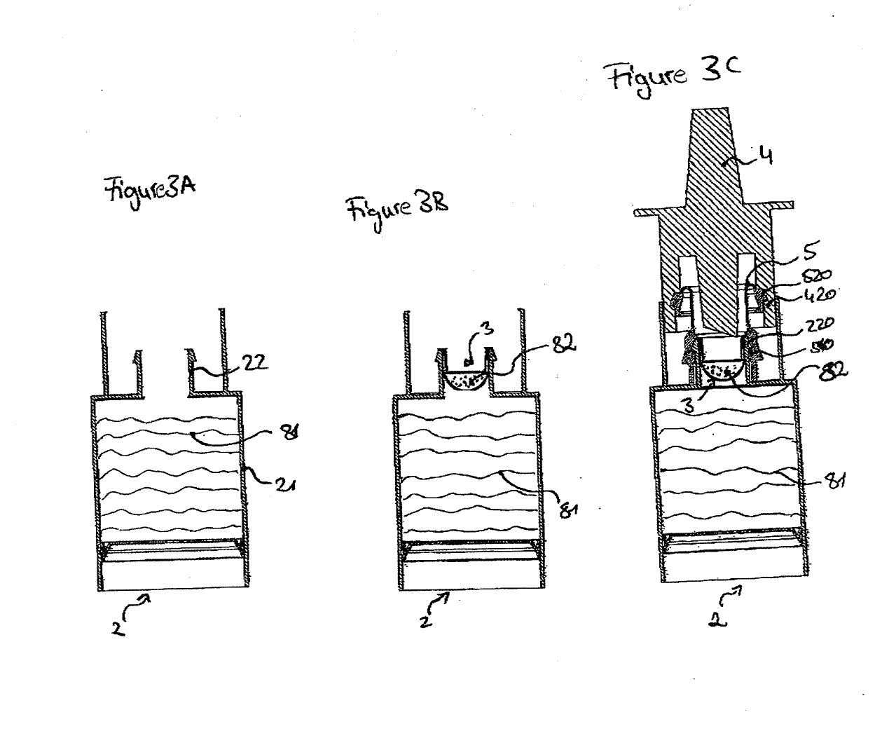

FIGS. 3A-C the manufacturing sequence of a metering device according to the invention;

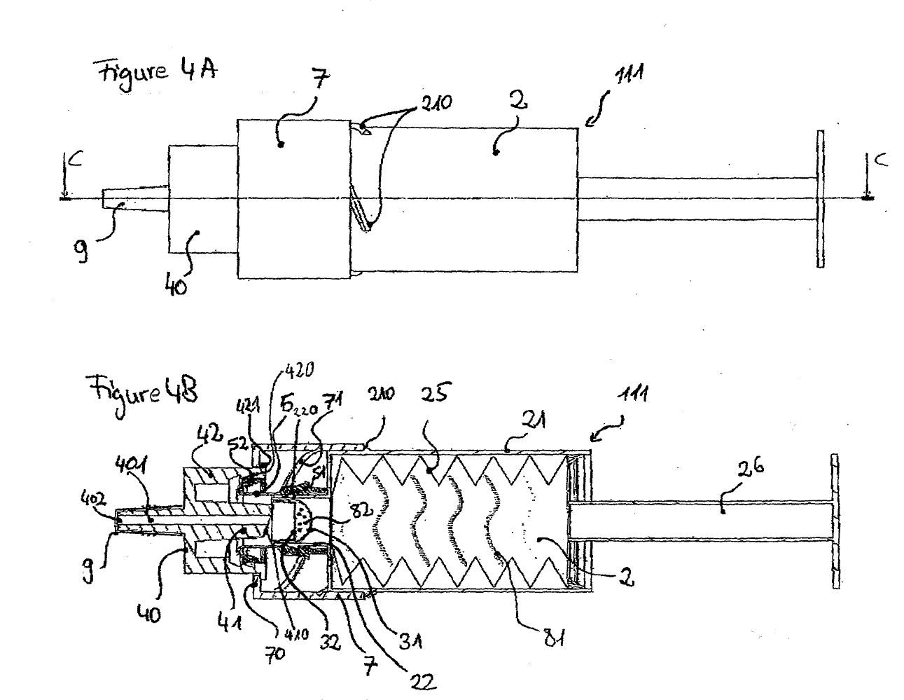

FIGS. 4A and B a longitudinal section through a metering device according to the invention configured as a disposable syringe in non-activated position; and

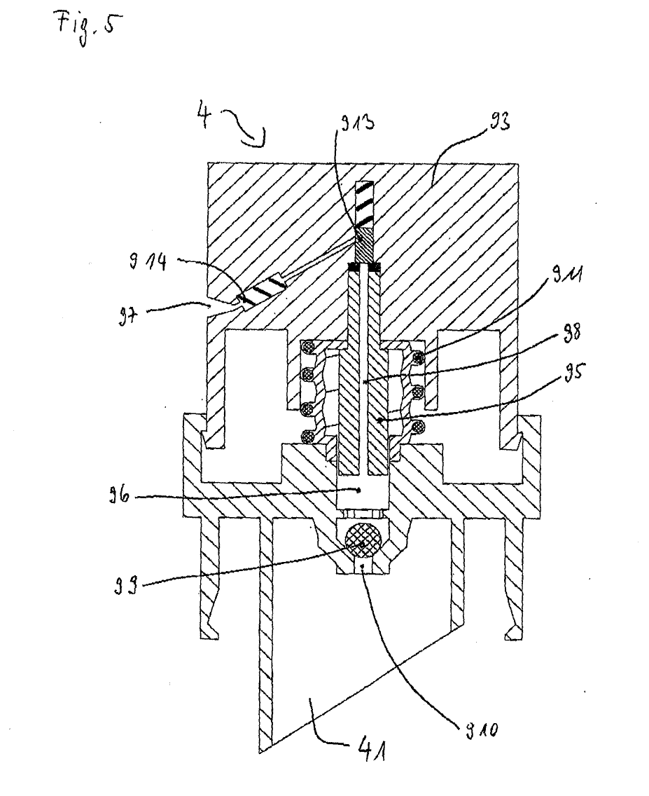

FIG. 5 a longitudinal section through a metering pump.

FIG. 1A shows a front view of a metering device 1 according to the invention in non-activated position which can be activated by pressing. In FIG. 1B, the section A-A through the metering device indicated in FIG. 1A is represented.

The metering device 1 has a storage vessel 2, an inner vessel 3 and an output unit designed as metering pump 4. The storage vessel 2 comprises a cylindrical vessel body 21, a cylindrical storage vessel neck 22, the diameter of which is less than that of the vessel body 21, and also a guide cylinder 23, the diameter of which adopts a value between that of the vessel body 21 and of the neck 22. In addition, the storage vessel 2 has a trailing piston 24 at the bottom thereof. The inner vessel 3 comprises a first layer 31 and a second layer 32. The first layer 31 is welded by its edge on the end of the storage vessel neck 22 which is orientated away from the vessel body 21 and is suspended bulging into the neck 22. The second layer 32 of the inner vessel 3 is likewise disposed by its layer edge on the end of the neck 22 orientated away from the vessel body 21 and is suspended bulging slightly into the neck 22.

The metering pump 4 has an inlet connection piece 41 and also a hollow cylinder 42 which surrounds the inlet connection piece 41 concentrically. In the interior thereof, the metering pump 4 has the following components, not represented: pump piston, pump chamber and a nozzle connected to the pump chamber via an outlet channel.

A sealed connection between the storage vessel 2 and the metering pump 4 is produced by a flexible plastic material tube 5 which is secured in the region of the neck 22 and also of the hollow cylinder 42. The plastic material tube 5 is represented in FIG. 1D in an enlarged view. FIG. 1D shows that the neck 22 has an undercut 220 at the region thereof orientated away from the vessel body 21. Similarly, also the cylinder 42 has an undercut 420 on its inside. The tube 5 has a thickened portion 51 in the region with which it is turned over the neck 22 of the storage vessel 2, which thickened portion has an undercut 510 on the inside of the tube 5 and also a projection 511 on the side orientated away from the neck 22. The undercut 510 of the tube 5 and the undercut 220 of the neck 20 engage one in the other in a form fit.

In the region 52, in which the tube 5 is in contact with the cylinder 42, the inside of the tube 5 is turned over outwards. On the side orientated towards the cylinder 42, i.e. on the actual inside of the tube 5, the tube 5 has a projection 520 there which is in engagement with the undercut 420 of the hollow cylinder 42. Furthermore, the region 52 has a projection 521 which is disposed on the side of the region 52 orientated away from the hollow cylinder 42.

In order to bring the metering device 1 according to the invention, represented in FIGS. 1A and B, into the position of use, the metering pump 4 is moved in the direction of the storage vessel 2. The first 31 and the second 32 layer of the inner vessel 3 is thereby penetrated by the inlet connection piece 41 which is pointed at its end and has a cutting collar 410.

FIG. 1C now shows the metering device 1 in the position of use. The inlet connection piece 41 of the metering pump 4 is now situated in the region of the neck 22 in which previously the inner vessel 3 was positioned. In the position of use of the metering device 1, the tube 5 is rolled inwards into the pump head, i.e. into the region between hollow cylinder 42 and inlet connection piece 41.

FIG. 1E shows an enlarged section of a part of the tube 5 which illustrates that the projection 511 in the region 51 of the tube 5 is in engagement with the projection 521 of the region 52 of the tube 5 and the metering pump 4 is locked to the storage vessel 2.

FIG. 2A shows the front view of a further embodiment of a metering device 11 according to the invention, activation being effected by a screwing movement. FIG. 2B represents a longitudinal section through the metering device, designated in FIG. 2A with B-B.

The metering device has in turn a storage vessel 2 with a vessel body 21 and a storage vessel neck 22. In the storage vessel 2, bellows 25 are represented, the bellows 25 and the base configured as trailing piston base 24 enabling a pressure equalisation. The bellows 25 are filled with a liquid first substance 81.

At the orientated-away end of the neck 22, the edge of the first layer 31 and of the second layer 32 of the inner vessel 3 which is filled with a pulverulent second substance 82 is mounted or welded-on to form a seal. In addition, the metering device 11 has a metering pump 4 with an inlet connection piece 41, the end of which, orientated towards the storage vessel 2, is pointed and has a cutting collar 410, and with a hollow cylinder 42 which surrounds the inlet connection piece 41. The metering pump 4 is in turn connected to the storage vessel neck 22 via a flexible plastic material tube 5 which is configured like the tube 5 described in the description of FIGS. 1A to E.

In contrast to the metering device 1 represented in FIGS. 1A to E, the metering pump 4 in FIG. 2A has an outwardly projecting edge 421, i.e. an edge pointing away from the inlet connection piece 41, in the region of the hollow cylinder 42 orientated towards the storage vessel 2. Furthermore, the metering device 11 has a screwed bush 7 for guiding the metering pump 4 in the direction of the storage vessel 2. The screwed bush 7 is configured as a hollow cylinder which has an inwardly projecting edge 70 at its end orientated towards the metering pump 4. The edge 70 engages in the edge 421. Furthermore, the screwed bush has threads 71 on the inside thereof, into which threads webs 210 which surround the vessel body 21 spirally can be guided.

FIG. 2D shows an enlarged section of the tube 5. In addition, the screwed bush 7 and a thread 71 are represented.

If a user now turns the screwed bush 7 in clockwise direction, then the screwed bush 7 is guided downwards and, at the same time, the metering pump 4 is drawn in the direction of the storage vessel 2. The inlet connection piece 41 thereby penetrates the inner vessel 3 so that the substance falls out of the inner vessel 3 into the storage vessel 2 and is mixed with the first substance.

FIG. 2C shows the metering device 11 in the activated state. The screwed bush 7 is rotated in clockwise direction up to the limit stop and the metering pump 4 is moved so far in the direction of the vessel body 21 that the inlet connection piece 41 is disposed in the region of the neck 22. In turn, the tube 5 is rotated into the intermediate space between inlet connection piece 41 and hollow cylinder 42. As represented in FIG. 2E in enlarged form, in addition the projection 511 and the projection 521 are in engagement with each other and the metering pump 4 is hence locked on the storage vessel 2.

In FIG. 2E, it is illustrated in addition that the web 210 of the vessel body 21 is guided in the thread 71 of the screwed bush 7.

FIGS. 3A to C show the manufacturing sequence of a metering device 1 according to the invention. In a first step, the storage vessel 21 is filled with a liquid substance 81, at least the region of the neck 22 remaining empty. The filled storage vessel 2 is represented in FIG. 3A.

In a second step, an inner vessel 3 already filled with a powder 82 is disposed in the region of the neck 22 such that the storage vessel 2 is sealed. FIG. 3B shows the storage vessel 2 with the liquid 81 and the inner vessel 3 with the powder 82 which is suspended bulging in the region of the neck 22.

In a third step, the metering pump 4 and the flexible plastic material tube 5 is now placed on the storage vessel 2. For this purpose, firstly the plastic material tube with the undercut 520 is inserted into the undercut 420 of the metering pump 4. Subsequently, the tube 5 is turned over the neck 22 so that the undercut 220 on the neck 22 engages with the undercut 510 of the tube 5. A filled metering device 1 is represented in FIG. 3C.

As is represented in FIGS. 4A and B in front view and as longitudinal section C-C, the metering device according to the invention can also be configured as a disposable syringe 111.

The disposable syringe 111 has a storage vessel 2, an inner vessel 3, an output cap 40 and a screwed bush 7. The storage vessel 2 comprises a cylindrical vessel body 21, a vessel neck 22 with undercuts 220 and also a plunger 26 which is pressed in the direction of the storage vessel neck 22 in order to spray out a liquid 81. The liquid 81 is situated in the interior of bellows 25 which are surrounded by the vessel body 21.

The inner vessel 3 consists of a first 31 and a second 32 layer, between which a powder 82 is stored in the non-activated state of the syringe 111. The two layers 31 and 32 which have a round configuration are applied or glued-on to form a seal with their edge on the end of the storage vessel neck 22 which is orientated away from the storage vessel 2.

The output cap 40 has an inlet connection piece 41 with a diagonal cutting collar 410 and a channel 401 which extends in the inlet connection piece 41 and through which the final liquid preparation can emerge through an outlet opening 402 in the position of use. The outlet opening 402 is covered and sealed by a closing cap 9.

The output cap 40 has furthermore a hollow cylinder 42 which surrounds the inlet connection piece 41. The hollow cylinder 42 includes undercuts 420 on the inside thereof and an outwardly projecting edge 421 at the end thereof orientated towards the storage vessel 2.

The output cap 40, as described in the embodiments represented in FIGS. 1A to E and 2A to E, is connected to the storage vessel 2 in an air- and water-tight manner, as is already known from the previous examples, via a flexible plastic material tube 5. The tube 5 is turned over the storage vessel neck 22 by its region 51 and is in engagement with the hollow cylinder 42 of the output cap 40 by its region 52. The regions 51 and 52 of the tube 5 are locked in the position of use.

The screwed bush 7 is configured as in the example of the metering device 11 of FIGS. 2A to E. On the inside of its cylindrical body, it has threads in which the webs 210 on the outside of the storage vessel body 21 can be guided. The screwed bush 7 is in engagement with the edge 421 of the output cap 40 by its edge 70.

For activation, the output cap 40 with the inlet connection piece 41 is drawn in the direction of the storage vessel body 21 by a quarter turn of the screwed bush 7 and the inner vessel 3 is penetrated by the inlet connection piece so that the powder 82 is introduced into the liquid substance 81. In an alternative variant, activation can also be effected by pressing. In order to accelerate the mixing- or dissolving process, the disposable syringe can be shaken.

In FIG. 5, a longitudinal section through a metering pump 4 which can be used for the metering device 1 according to the invention is represented. After activation of the activation body 93, the liquid preparation passes through an inlet connection piece 41 which surrounds the inlet opening 910 with the inlet valve 99, and through the pump chamber 96 and also the supply pipe 98 which is surrounded by the pump piston 95 into the outlet valve 913. Before the liquid is ejected through the nozzle 97, it passes through the silver spiral 914. By means of the silver spiral 914, efficient sterilisation of the liquid in the region of the nozzle 97 is maintained. The restoring springs 911 serve for automatic return of the activation body 93 into the starting position.

The present invention enables long-term storage of preparations since not only is good sealing of the metering device provided but a separation of the substances during a storage time is achieved, as a result of which the stability of the individual substances is prolonged.

1. A metering device for metered output of a liquid preparation comprising at least a first and a second starting substance, the metering device having a storage vessel, for receiving at least the first starting substance, with at least one opening, and an output unit having at least one passage channel with two channel openings, the output unit and the storage vessel being disposed relative to each other such that one of the channel openings and the opening of the storage vessel are orientated towards each other and the output unit, in the region of the opening of the storage vessel, is connected to the storage vessel in a sealed manner,
the region of the output unit orientated towards the storage vessel being configured as a penetration unit which can be introduced into the opening of the storage vessel and/or can be guided in the latter; and
in the region of the opening of the storage vessel between storage vessel and output unit, an inner vessel, which is sealed at least relative to the storage vessel, for receiving the second starting substance being disposed, the inner vessel being able to be penetrated with the help of the penetration unit of the output unit.

2. The metering device according to claim 1, wherein the output unit, after penetration of the inner vessel, is locked to the storage vessel.

3. The metering device according to claim 1, wherein
the output unit has a hollow cylinder or a hollow prism which surround the penetration unit; in that
the hollow cylinder or the hollow prism have undercuts on their inside at least in regions; and in that
the storage vessel has undercuts in the region of its opening, the undercuts of the hollow cylinder or of the hollow prism and those of the storage vessel preferably being in direct or indirect engagement after penetration of the inner vessel.

4. The metering device according to claim 3, wherein the output unit and the opening of the storage vessel are connected by means of a flexible plastic material tube, the plastic material tube having at least respectively at least one thickened portion preferably in the regions which are connected to the hollow cylinder or hollow prism and/or to the storage vessel, which thickened portion is in engagement with the undercuts on the inside of the hollow cylinder or of the hollow prism and/or with the undercuts in the region of the opening of the storage vessel.

5. The metering device according to claim 1, wherein the penetration unit of the output unit is a pointed inlet connection piece or a cutting collar, a saw collar, a toothed collar, in particular a diagonal cutting-, saw- or toothed collar, at least one tine or at least one mandril.

6. The metering device according to claim 1, wherein the output unit is a metering pump which has an inlet channel, a pump piston, a pump chamber and a nozzle which is connected to the pump chamber via an outlet channel.

7. The metering device according to claim 1, wherein the metering device is a disposable syringe which has a plunger on the side of the storage vessel which is orientated away from the output unit.

8. The metering device according to claim 1, wherein the storage vessel contains a pressure-equalisation device.

9. The metering device according to claim 1, wherein the inner vessel, before penetration of the inner vessel, is configured as a closed vessel and/or the storage vessel is closed in a sealed manner.

10. The metering device according to claim 1, wherein the inner vessel is composed of metal, plastic material, aluminium with plastic material coating or glass, or comprises one of these materials.

11. The metering device according to claim 1, wherein the storage vessel has a hollow cylinder, or a hollow prism, the hollow cylinder or the hollow prism surrounding the opening of the storage vessel.

12. The metering device according to claim 11, wherein the hollow cylinder or the hollow prism serves as a guide for the output unit in order to avoid tilting.

13. The metering device according to claim 1, wherein the metering device has a screwed bush for guiding the metering pump in the direction of the storage vessel, the screwed bush preferably having one or more threads.

14. The metering device according to claim 1, wherein the inner vessel and/or the storage vessel contain protective gas and/or inert gas in order to protect the contents from oxidation and/or hydrolysis.

15. The metering device according to claim 1, wherein protective gas and/or inert gas is passed through the first starting substance, possibly before filling.

16. The metering device according to claim 1, wherein the inner vessel and/or the storage vessel is filled under an atmosphere comprising protective gas and/or inert gas.

17. The metering device according to claim 1, wherein the protective gas is selected from nitrogen, carbon dioxide or mixtures hereof thereof.

18. The metering device according to claim 1, wherein the inert gas is selected from nitrogen, noble gases, or mixtures thereof.

19. The metering device according to claim 1, wherein bellows are disposed in the storage vessel, as a result of which a hermetic seal of the metering device until the end of use is ensured.

20. Method for operating the metering device of claim 1, wherein the output unit being is moved in the direction of the storage vessel and the penetration unit penetrating the inner vessel.

21. The method according to claim 20, wherein the metering device is shaken after penetration of the inner vessel.

22. A method for administering medicinal products, pharmaceutical products, cosmetic products, cleaning agents, chemicals, foodstuffs, food supplements or liquid spices/herbs, or preservatives comprising metering the material to be administered with the device according to claim 1.

23. A method for administering preparations which comprise vitamins, minerals, enzymes, coenzymes, plant extracts, bacteria, yeasts as individual substance or mixtures of a plurality of these substances, the method comprising metering the preparation with the device according to claim 1.

24. The metering device of claim 10, wherein the inner vessel is composed of aluminum.

25. The metering device of claim 10, wherein the inner vessel is composed of plastic material that is polychlorotrifluoroethylene, cycloolefin polymer, polypropylene, polyethylene, and/or polymer films.
